(19) United States
(12) Patent Application Publication
(10) Pub. No.: US 2012/0249059 A1
(43) Pub. Date: Oct. 4, 2012

(54) SWITCHING POWER SUPPLY DEVICE

(75) Inventors: Hiroshi MATSUMAE, Obu-shi (JP); Yukio KARASAWA, Ota-shi (JP)

(73) Assignee: DENSO CORPORATION, Kariya-city (JP)

(21) Appl. No.: 13/433,687

(22) Filed: Mar. 29, 2012

(30) Foreign Application Priority Data
Mar. 31, 2011 (JP) 2011-076962

(51) Int. Cl. H02J 7/00; H02M 3/335

(52) U.S. Cl. 320/107; 363/17

(57) ABSTRACT

A switching power supply device includes a full-bridge circuit, a transformer, a rectifier circuit, a filter circuit, a first series connection of a snubber capacitor and a first diode, and a second diode. The full-bridge circuit includes switching elements which are controlled to be driven under phase-shift control. The first series connection is connected in parallel with the smoothing reactor, where one terminal is connected to a terminal on positive side of the rectifier circuit, and the other terminal is connected to an anode of the first diode. A cathode of the first diode is connected to one terminal of the smoothing capacitor which is applied with positive voltage. The second diode is provided between a terminal on negative side of the rectifier circuit and a connecting point of the snubber capacitor and the first diode. A cathode of the second diode is connected to the connecting point.

### CROSS-REFERENCE TO RELATED APPLICATION

This application is based on and claims the benefit of priority from earlier Japanese Patent Application No. 2011-076962 filed Mar. 31, 2011, the description of which is incorporated herein by reference.

### BACKGROUND OF THE INVENTION

1. Technical Field of the Invention

The present invention relates to a switching power supply device, and in particular, to a switching power supply device that includes a snubber capacitor for absorbing surge voltage.

2. Related Art

A switching power supply device using a snubber capacitor is known in the related art (see, e.g., JP-A-09-285126 and JP-A-01-295675). For example, as shown in FIG. 27, JP-A-09-285126 discloses a switching power supply device 91 which is provided between a load 913 and a power source 914 such as to adjust voltage applied to the load 913. The switching power supply device 91 includes a full-bridge circuit 92 connected to the power source 914, a transformer 93, a rectifier circuit 910, a smoothing capacitor 911 connected in parallel with the load 913, and a smoothing reactor 912 connected in series with the load 913. The full-bridge circuit 92 is configured by a plurality of switching elements Sa to Sd. The rectifier circuit 910 is configured by a plurality of rectifier diodes D1 to D4.

When the switching elements Sa to Sd of the full-bridge circuit 92 are turned on/off, a primary current I1 flows through a primary coil 931 of the transformer 93 and a secondary current I2 flows through a secondary coil 932 of the transformer 93. The secondary current I2 is rectified by the rectifier circuit 910. The voltage after rectification is smoothed by a filter circuit 999 that is configured by the smoothing reactor 912 and the smoothing capacitor 911. Thus, DC voltage is applied to the load 913. The switching power supply device 91 is configured in such a way that the voltage applied to the load 913 is adjusted by controlling the duration of an on state of the individual switching elements Sa to Sd.

As shown in FIG. 27, a part of the secondary coil 932 of the transformer 93 does not contribute to the voltage transformation but causes a leakage inductance L_{L}. Therefore, when the secondary current I2 flows through the secondary coil 932 (i.e., when secondary voltage is outputted), recovery current of the rectifier diodes flows. The recovery current corresponds to a reverse current of the accumulated electric charges of the diodes caused when the state of the diodes transits from a conducted state to a non-conducted state. The recovery current, being coupled with the leakage inductance L_{L}, generates a surge voltage. The surge voltage is applied to the rectifier diodes D1 to D4 in a reverse direction thereof to generate high surge voltage which is likely to cause failures in the rectifier diodes D1 to D4. In order to take measures against such failures, the switching power supply device 91 is provided with a snubber circuit 97.

The snubber circuit 97 includes a snubber capacitor Cs, a first diode Ds1 and a second diode Ds2. The snubber capacitor Cs and the first diode Ds1 are connected in series to configure a series connection 94. The serial connection 94 is connected in parallel with the smoothing reactor 912. The second diode Ds2 is connected between (i) a connecting point 98 of the snubber capacitor Cs and the first diode Ds1 and (ii) an output terminal 99 on the negative side of the rectifier circuit 910.

The secondary current I2 flows through the rectifier diode D3 (or rectifier diode D1) of the rectifier circuit 910, the snubber capacitor Cs, the first diode Ds1, the smoothing reactor 912, the smoothing capacitor 911, the load 913 and the rectifier diode D2 (or rectifier diode D4). Upon generation of the secondary current I2 (i.e., upon generation of the secondary voltage), the surge voltage is generated by the recovery current of the diodes and the leakage inductance L_{L}. However, the surge voltage is absorbed by the snubber capacitor Cs. Accordingly, the rectifier diodes D1 to D4 are hardly applied with a large surge voltage and thus are unlikely to have failures.

A larger capacitance of the snubber capacitor Cs enables easier absorption of the surge voltage. Therefore, it is desirable that a capacitor having a large capacitance is used as the snubber capacitor Cs.

The switching power supply device 91 controls an on/off operation of the switching elements Sa to Sd in such a manner that an on state where the secondary current I2 flows through the secondary coil 932 (see FIG. 27) alternates with an off state where the secondary current I2 does not flow therethrough (see FIG. 28). As shown in FIG. 27, the snubber capacitor Cs absorbs the surge voltage in an on state to accumulate electric charge. As shown in FIG. 28, the snubber capacitor Cs discharges the accumulated electric charge in an off state. Thus, a discharging current Id flows through the rectifier circuit 910 in an off state. Specifically, the discharging current Id flows through a closed circuit composed of the snubber capacitor Cs, the rectifier diodes D1 to D4 and the second diodes Ds2. The reason why the discharging current Id flows through the rectifier diodes D1 to D4 in a reverse direction is as follows.

As shown in FIG. 27, in an on state, a reactor current I_{L} flows through the smoothing reactor 912. The smoothing reactor 912 attempts to keep the reactor current I_{L} flowing when the state of the secondary coil 932 has turned to an off state as well (see FIG. 28).

In an off state, the reactor current I_{L} flows through the rectifier diodes D1 to D4 in a forward direction. The reactor current I_{L} is larger than the discharging current Id of the snubber capacitor Cs. Accordingly, the discharging current Id flows in a direction opposite to the direction of the reactor current I_{L}, so that the reactor current I_{L} is reduced. Thus, the discharging current Id apparently flows through the rectifier diodes D1 to D4 in a reverse direction.

However, the switching power supply device 91, a typical switching power supply device based on conventional art, is not provided with a resistor, a coil or the like for suppressing the discharging current Id of the snubber capacitor Cs, in a path through which the discharging current Id flows. Being not provided with such a resistor or the like, such a switching power supply device of conventional art has suffered from a problem that a high discharging current Id flows through the path. Further, in such a switching power supply device of conventional art such as the switching power supply device 91 explained above, the device turns to an on state after a large amount of electric charges are discharged from the snubber capacitor Cs, which is again followed by the charging of the snubber capacitor Cs. In this charging of the snubber capacitor Cs following the discharging of a large amount of electric charges, the charging current becomes necessarily large.

As mentioned above, the snubber capacitor Cs is required to have a large capacitance in order to sufficiently absorb the surge voltage. However, an excessively large capacitance permits the charging current and the discharging current Id to be large, leading to a problem of large power loss of the switching power supply device 91.

### SUMMARY

It is thus desired to provide a switching power supply device which is able to easily reduce surge voltage and causes less power loss.

An exemplary embodiment provides a switching power supply device, comprising: a full-bridge circuit that includes a plurality of switching elements which are controlled to be driven under phase-shift control; a transformer that includes a primary coil and a secondary coil, the primary coil being connected to an output terminal of the full-bridge circuit; a rectifier circuit that is connected to the secondary coil of the transformer and rectifies a secondary voltage outputted from the secondary coil; a filter circuit that includes a smoothing capacitor and a smoothing reactor, which smooths the rectified secondary voltage; a first series connection that is configured by a snubber capacitor and a first diode which are connected in series with each other, the first series connection being connected in parallel with the smoothing reactor, one terminal of the snubber capacitor being connected to a terminal on a positive side of the rectifier circuit, the other terminal of the snubber capacitor being connected to an anode of the first diode, and a cathode of the first diode being connected to one terminal of the smoothing capacitor which is applied with positive voltage; and a second diode that is provided between a terminal on a negative side of the rectifier circuit and a connecting point of the snubber capacitor and the first diode, a cathode of the second diode being connected to a side of the connecting point.

In the switching power supply device as set forth above, the switching elements of the full-bridge circuit are operated under phase-shift control. Thus, owing to the effect of the phase-shift control, secondary-side return (back-flow) current flows through the secondary coil of the transformer in a period when the snubber capacitor carries out discharging. In equivalent circuits of the transformer (see, e.g., FIGS. 18 and 19 as explained later), a primary-side leakage inductance and a secondary-side leakage inductance are expressed by a series circuit (excitation inductance is much larger than leakage inductance). The secondary-side return current flows through the series circuit composed of the primary- and secondary-side leakage inductances. Hereinafter, the primary- and secondary-side inductances as a whole are referred to as a total leakage inductance.

With the configuration set forth above, the discharging current of the snubber capacitor flows through the total leakage inductance, as will be described later. Thus, a flow of high discharging current is prevented by the total leakage inductance. Accordingly, power loss of the switching power supply device is reduced. Further, in spite of the increase in the capacitance of the snubber capacitor, the discharging current can be reduced. Thus, the snubber capacitor having a large capacitance may be used so that surge voltage can be easily absorbed. As a result, the rectifier diodes are easily protected.

In the exemplary embodiment, under phase-shift control, leakage inductance of the transformer may be used as a resonant inductance (inductance for allowing reverse current to flow). However, an independent inductance may be separately provided and additionally connected in series to a transformer's terminal. In this case, the added inductance is further added to the total leakage inductance.

As set forth above, the switching power supply device according to the exemplary embodiment easily reduces surge voltage, with less power loss.

The exemplary embodiment, the switching power supply device may further comprise a second series connection of the second diode and an impedance that discharges electric charges that are connected in series with each other, the second series connection being provided between the connecting point and the terminal on the negative side of the rectifier circuit.

In this case, the discharging current of the snubber capacitor flows through both of the total leakage inductance and the impedance for discharging electric charges. Accordingly, the discharging current is more effectively reduced. Thus, the capacitance of the snubber capacitor can be easily increased as desired and thus surge voltage is easily absorbed. At the same time, power loss of the switching power supply device is more effectively reduced.

In the exemplary embodiment, the impedance may be an inductance.

In this case, the amount of generated heat is reduced when the discharging current flows through the switching power supply device, compared to the case where a resistor is used as the impedance for discharging electric charges. Thus, power loss of the switching power supply device is easily reduced.

In the exemplary embodiment, the switching elements may be controlled to be driven in such a manner that an on state where the secondary coil outputs a secondary voltage repeatedly alternates with an off state where the secondary coil does not output the secondary voltage, and the snubber capacitor may have capacitance which is set so that voltage across the snubber capacitor is not reduced to zero volts in the off state.

Thus, the snubber capacitor in this case has so large a capacitance that will not allow the voltage across the snubber capacitor to be reduced to 0 V (zero volts) in the off state. Thus, surge current of the secondary coil is more effectively absorbed.

### BRIEF DESCRIPTION OF THE DRAWINGS

In the accompanying drawings:

FIG. 1 is a circuit diagram of a switching power supply device according to a first embodiment of the present invention;

FIG. 2 is a diagram showing an operation of a full-bridge circuit, according to the first embodiment;

FIG. 3 is a waveform chart of rectified secondary voltage of a transformer and voltage across a snubber capacitor, according to the first embodiment;

FIG. 4 is a diagram showing a path of current flowing through the full-bridge circuit in a state of (A) in FIG. 2;

FIG. 5 is a diagram showing a path of current flowing through the full-bridge circuit in a state of (B) in FIG. 2;

FIG. 6 is a diagram showing a path of current flowing through the full-bridge circuit in a state of (C) in FIG. 2;

FIG. 7 is a diagram showing a path of current flowing through the full-bridge circuit in a state of (D) in FIG. 2;

FIG. 8 is a diagram showing a path of current flowing through the full-bridge circuit in a state of (E) in FIG. 2;

FIG. 9 is a diagram showing a path of current flowing through the full-bridge circuit in a state of (F) in FIG. 2;

FIG. 10 is a diagram showing a path of current flowing through the full-bridge circuit in a state of (G) in FIG. 2;

FIG. 11 is a diagram showing a path of current flowing through the full-bridge circuit in a state of (H) in FIG. 2;

FIG. 12 is a diagram showing a path of current flowing through the full-bridge circuit in a state of (I) in FIG. 2;

FIG. 13 is a diagram showing a path of current flowing through the full-bridge circuit in a state of (J) in FIG. 2;

FIG. 14 is a diagram showing a path of current flowing the switching power supply device in a state where switching elements Sa and Sd are turned on, according to the first embodiment;

FIG. 15 is a diagram showing a path of current flowing the switching power supply device in a state where switching elements Sa and Sc are turned on, according to the first embodiment;

FIG. 16 is a diagram showing a path of current flowing the switching power supply device in a state where switching elements Sb and Sc are turned on, according to the first embodiment;

FIG. 17 is a diagram showing a path of current flowing the switching power supply device in a state where switching elements Sb and Sd are turned on, according to the first embodiment;

FIG. 18 is an equivalent circuit of the switching power supply device in the state shown in FIG. 15;

FIG. 19 is an equivalent circuit of the switching power supply device in the state shown in FIG. 17;

FIG. 20 is a circuit diagram of a switching power supply device according to a second embodiment of the present invention;

FIG. 21 is a circuit diagram of a switching power supply device that is applied to a battery charger, according to a third embodiment of the present invention;

FIG. 22 is a circuit diagram of a switching power supply device according to a comparative example;

FIG. 23 is a graph showing waveforms of secondary voltage and secondary current of a transformer of the switching power supply device illustrated in FIG. 22 under hard-switching control;

FIG. 24 is a graph showing waveforms of secondary voltage and secondary current of the transformer of the switching power supply device shown in FIG. 22 under phase-shift control;

FIG. 25 is a graph showing waveforms of secondary voltage and secondary current of a transformer of the switching power supply device shown in FIG. 1 under hard-switching control;

FIG. 26 is a graph showing waveforms of secondary voltage and secondary current of the transformer of the switching power supply device shown in FIG. 1 under phase-shift control;

FIG. 27 is a circuit diagram of a switching power supply device in a state where a snubber capacitor is being charged, according an example of the related art; and

FIG. 28 is a circuit diagram of a switching power supply device in a state where a snubber capacitor is being discharged, according the example of the related art.

### DETAILED DESCRIPTION OF THE PREFERRED EMBODIMENTS

With reference to the accompanying drawings, hereinafter are described some embodiments of a switching power supply device according the present invention.

The switching power supply device of the present invention may be used for a battery charger which uses a household plug socket in charging a battery installed such as in an electric car or a hybrid car.

### First Embodiment

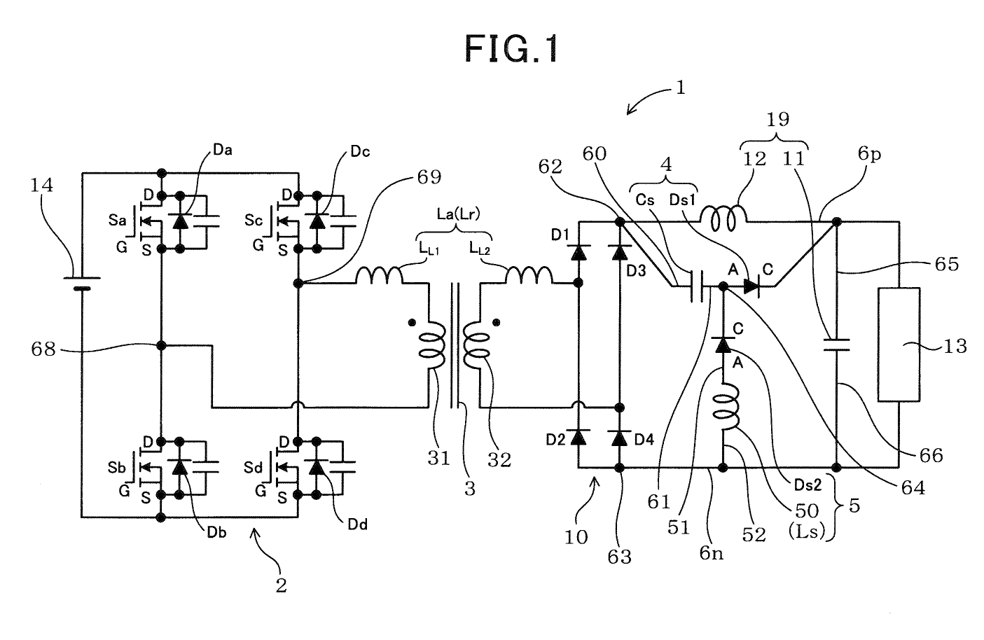

Referring, first, to FIGS. 1 to 17, hereinafter is described a switching power supply device 1 according to a first embodiment of the present invention.

As shown in FIG. 1, the switching power supply device 1 according to the first embodiment, which is connected between a load 13 and a power source 14, includes a full-bridge circuit 2, a transformer 3, a rectifier circuit 10, a smoothing capacitor 11, a smoothing reactor 12, and a first series connection 4. The smoothing reactor 12 and the smoothing capacitor 11 configures a filter circuit 19.

The full-bridge circuit 2 includes a plurality of switching elements S (Sa to Sd). The transformer 3 includes a primary coil 31 and a secondary coil 32. The full-bridge circuit 2 has an output terminal which is connected to the primary coil 31. The rectifier circuit 10, which has an output terminal 62 on the positive side and an output terminal 63 on the negative side, is connected to the secondary coil 32 of the transformer 3 to rectify secondary voltage outputted from the secondary coil 32. The smoothing reactor 12 and the smoothing capacitor 11 smooth the secondary voltage rectified by the rectifier circuit 10. The smoothing reactor 12 is connected in series with the smoothing capacitor 11. The first series connection 4 is composed of a snubber capacitor Cs having terminals 60 and 61, and a first diode Ds1. The snubber capacitor Cs and the first diode Ds1 are connected in series. The first series connection 4 is connected in parallel with the smoothing reactor 12.

In the snubber capacitor Cs, one terminal 60 is connected to the positive-side output terminal 62 of the rectifier circuit 10, and the other terminal 61 is connected to the anode of the first diode Ds1. The cathode of the first diode Ds1 is connected to a terminal 65, which is applied with positive voltage, of the smoothing capacitor 11.

The snubber capacitor Cs is connected to the first diode Ds1 via a connecting point 64. A second diode Ds2 is provided between the connecting point 64 and the negative-side output terminal 63 of the rectifier circuit 10. The cathode of the second diode Ds2 is connected to the connecting point 64.

The switching power supply device 1 is ensured to operate the switching elements S (Sa to Sd) of the full-bridge circuit 2 under phase-shift control.

The switching power supply device 1 of the present embodiment, in which the duties of the switching elements S (Sa to Sd) are controlled, is used as a DC-DC converter for adjusting the voltage applied to the load 13.

In the present embodiment, MOSFETs (metal-oxide-semiconductor field-effect transistors) are used as the switching elements Sa to Sd of the full-bridge circuit 2. The switching elements S include first and third switching elements Sa and Sc composing an upper arm, and second and fourth switching elements Sb and Sd composing a lower arm. The switching elements S are connected with respective diodes Da to Dd (parasitic diodes of the MOSFETs, hereinafter referred to as “first to fourth flywheel (or freewheel) diodes Da to Dd”). Further, the switching elements S are connected with respective capacitors (parasitic capacitors of the MOSFETs).

The source of the first switching element Sa is connected to the drain of the second switching element Sb. The source of the third switching element Sc is connected to the drain of the fourth switching element Sd. The drains of the first and third switching elements Sa and Sc are both connected to a positive terminal of the power source 14 (DC power source). The sources of the second and fourth switching elements Sb and Sd are both connected to a negative terminal of the power source 14. The gates of the individual switching elements S are connected to a control circuit, not shown. The switching elements S are turned on/off by the control circuit.

The first and second switching elements Sa and Sb are connected to each other via a connecting point 68. The third and fourth switching elements Sc and Sd are connected to each other via a connecting point 69. The primary coil 31 of the transformer 3 is connected between the connecting points 68 and 69. A part of the primary coil 31 does not contribute to voltage transformation but turns to a primary-side leakage inductance L_{L1}.

The secondary coil 32 of the transformer is connected to the rectifier circuit 10. A part of the secondary coil 32 does not contribute to voltage transformation but turns to a secondary-side leakage inductance L_{L2}.

The positive-side output terminal 62 of the rectifier circuit 10 is connected to the load 13 via a positive-side power line 6p. The negative-side output terminal 63 of the rectifier circuit 10 is connected to the load 13 via a negative-side power line 6n. The positive-side power line 6p is provided with the smoothing reactor 12. The smoothing capacitor 11 is connected between the positive- and negative-side power lines 6p and 6n so as to be in parallel with the load 13.

As mentioned above, the smoothing reactor 12 is connected in parallel with the first series connection 4. The first series connection 4 is composed of the snubber capacitor Cs and the first diode Ds1 which are connected in series.

The switching power supply device 1 of the present embodiment is provided with a second series connection 5 composed of the second diode Ds2 and an impedance 50 (snubber inductance Ls) for discharging electric charges, which are connected in series. The cathode of the second diode Ds2 is connected to the connecting point 64 between the snubber capacitor Cs and the first diode Ds1. The anode of the second diode Ds2 is connected to one of the terminals, i.e. a terminal 51, of the snubber inductance Ls. The other of the terminals, i.e. a terminal 52, of the snubber inductance Ls is connected to the negative-side power line 6n.

The switching power supply device 1 of the present embodiment is configured in such a way that the switching elements Sa to Sd of the full-bridge circuit 2 are turned on/off to apply AC voltage (primary voltage) to the secondary coil 31 of the transformer 3. With the application of the AC voltage, secondary voltage is generated in the secondary coil 32. The secondary voltage is rectified by the rectifier circuit 10 and smoothed by the smoothing reactor 12 and the smoothing capacitor 11.

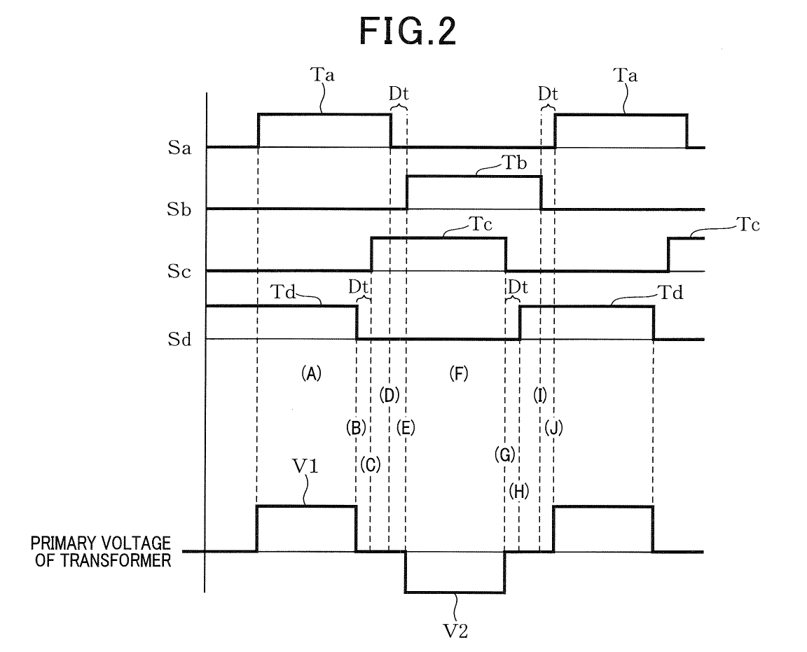

As shown in FIG. 2, in the present embodiment, the switching elements Sa to Sd of the full-bridge circuit 2 are operated under phase-shift control. Specifically, the first and second switching elements Sa and Sb are turned on/off as a pair, while the third and fourth switching elements Sc and Sd are turned on/off as another pair. The phase of an operation waveform of the third and fourth switching elements Sc and Sd is offset from the phase of the first and second switching elements Sa and Sb. Thus, an adjustment is made to the duration in which the first and fourth switching elements Sa and Sd (or the second and third switching elements Sb and Sc) are both in an on state. In this way, the pulse widths of pulsed voltages V1 and V2, which are applied to the primary coil 31, are controlled.

The on states of the first and second switching elements Sa and Sb are not overlapped with each other, but a delay period Td is interposed between a period Ta when the first switching element Sa is in an on state and a period Tb when the second switching element Sb is in an on state. Similarly, the on states of the third and fourth switching elements Sc and Sd are not overlapped with each other, but a delay period Dt is interposed between a period Tc when the third switching element Sc is in an on state and a period Dt when the fourth switching element Sd is in an on state. The duration and the cycle of an on state are fixed for each of the switching elements Sa to Sd.

The pulsed voltage V1 is applied to the primary coil 31 of the transformer 3 when both of the first and fourth switching elements Sa and Sd are in an on state. Also, the pulsed voltage V2, which is directed to a direction opposite to that of the voltage V1, is applied to the primary coil 31 when both of the second and third switching elements Sb and Sc are in an on state.

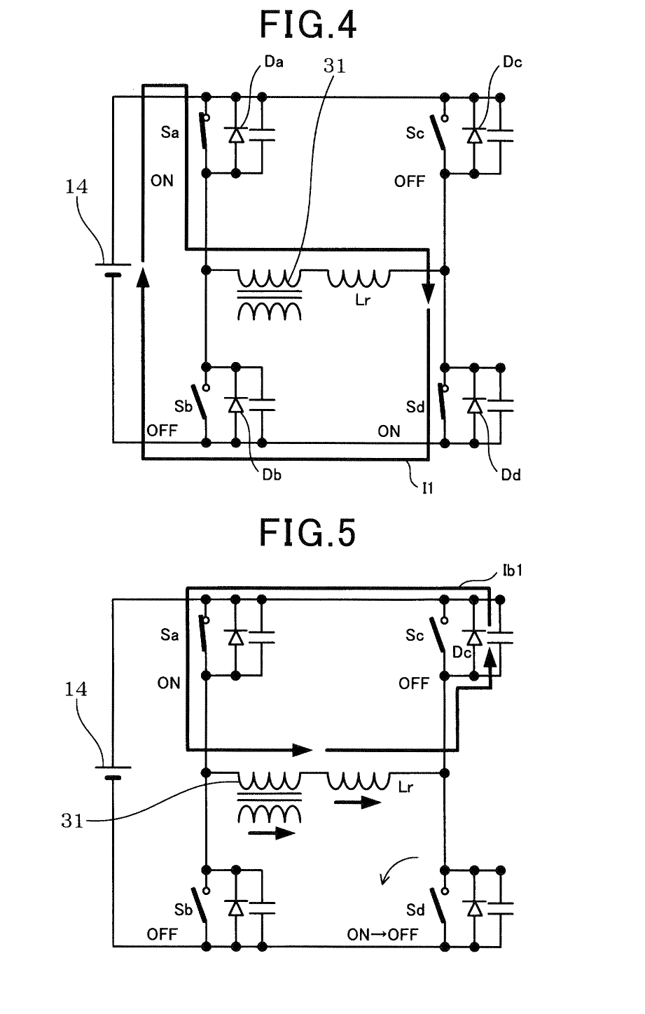

Referring to FIGS. 4 to 13, a path of current flowing through the full-bridge circuit 2 is described. FIGS. 4 to 13 each show an equivalent circuit including the full-bridge circuit 2 and the primary coil 31 illustrated in FIG. 1, and a resonant inductance Lᵣ. In the present embodiment, a total leakage inductance Lₐ from the perspective of the primary side is used as the resonant inductance Lᵣ. As a matter of course, a separate inductance may be additionally provided. FIGS. 4 to 13 correspond to (A) to (J), respectively, of FIG. 2.

As shown in FIG. 4, when only the first and fourth switching elements Sa and Sd are in an on state [i.e., state (A) in FIG. 2], the primary current I1 flows through the first switching element Sa, the primary coil 31, the resonant inductance Lᵣ and the fourth switching element Sd. In this state, when the fourth switching element Sd is turned off [i.e., state (B) in FIG. 2], the resonant inductance Lᵣ attempts to keep current flowing, as shown in FIG. 5, generating a primary-side return current Ib1. The primary-side return current Ib1 flows through a closed circuit composed of a third flywheel diode Dc, the first switching element Sa, the primary coil 31 and the resonant inductance Lᵣ.

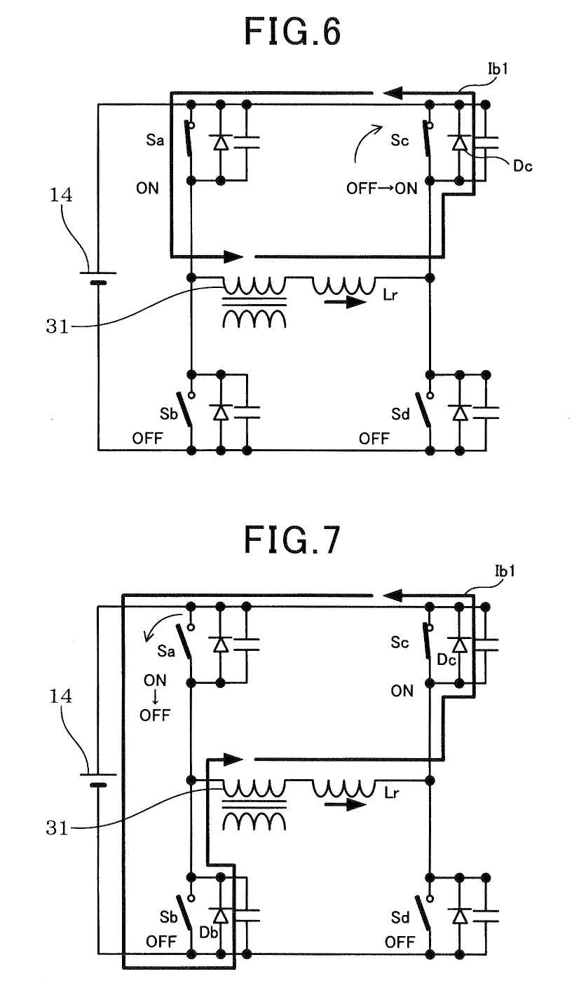

When the primary-side return current Ib1 flows through the third flywheel diode Dc, the potential difference across the terminals of the third switching element Sc is reduced to the level of the forward voltage of the third flywheel diode Dc. After that, as shown in FIG. 6, the third switching element Sc is turned on [i.e., state (C) in FIG. 2]. Controlling the on/off operation in this way, power loss in the third switching element Sc is reduced.

Then, as shown in FIG. 7, the first switching element Sa is turned off [i.e., a state of (D) in FIG. 2] while the primary-side return current Ib1 is flowing. In this state, the primary-side return current Ib1 comes to flow through a closed circuit composed of the third flywheel diode Dc, the power source 14, a second flywheel diode Db, the primary coil 31 and the resonant inductance Lᵣ.

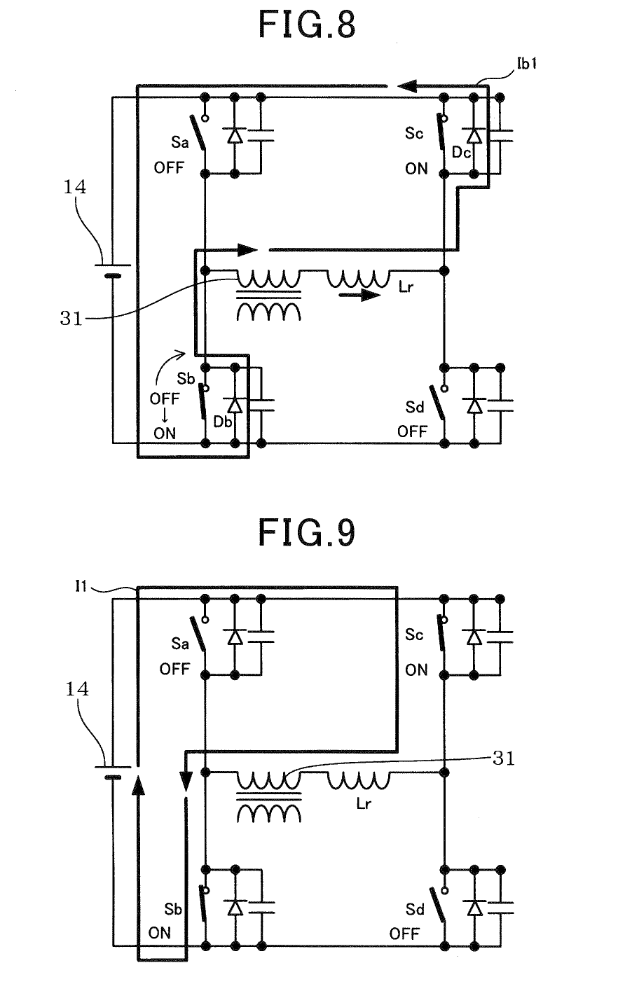

When the primary-side return current Ib1 flows through the second flywheel diode Db, the voltage across the terminals of the second switching element Sb is reduced to the level of the forward voltage of the second flywheel diode Db. Then, as shown in FIG. 8, the second switching element Sb is turned on [i.e., state (E) in FIG. 2].

After a while in this state, the primary-side return current Ib1 is attenuated and, as shown in FIG. 9, the voltage of the power source 14 allows the primary current I1 to start flowing. The primary current I1 flows through the third switching element Sc, the primary-side leakage inductance L_{L1}, the primary coil 31 and the second switching element Sb. In the state shown in FIG. 9 [i.e., state (F) in FIG. 2], the direction of the flow of the primary current I1 in the primary coil 31 is opposite to the direction of the current flow in the state shown in FIG. 4.

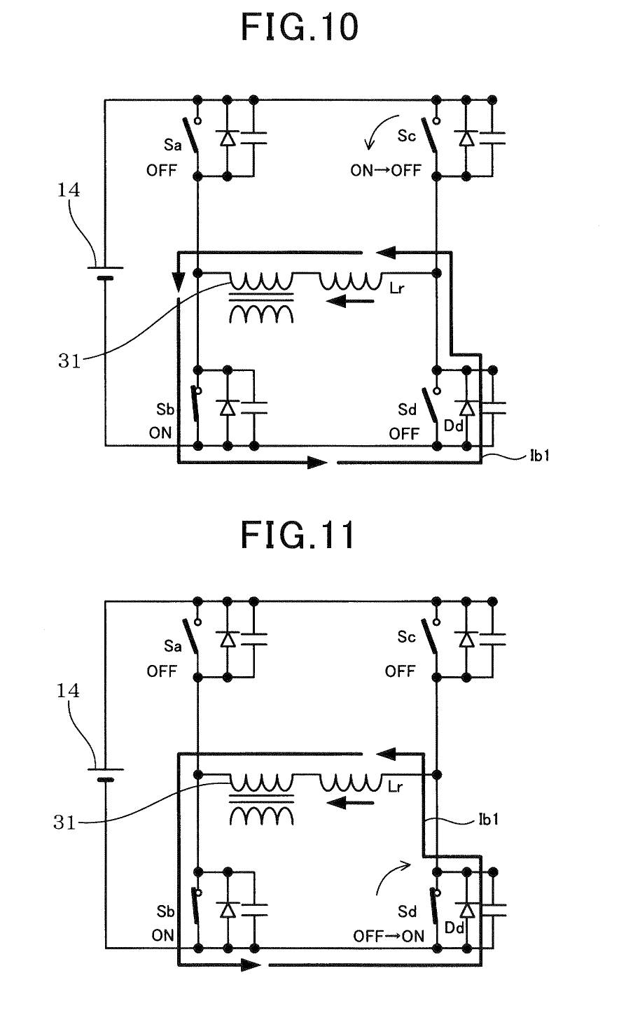

After that, as shown in FIG. 10, the third switching element Sc is turned off [i.e., state (G) in FIG. 2]. In this state, the resonant inductance Lᵣ attempts to keep current flowing and thus the primary-side return current Ib1 is again generated. The primary-side return current Ib1 flows through a closed circuit composed of a fourth flywheel diode Dd, the resonant inductance Lᵣ, the primary coil 31 and the second switching element Sb. In FIG. 10, the direction of the primary-side return current Ib1 flowing through the resonant inductance Lᵣ is opposite to the direction shown in FIGS. 5 to 8.

When the primary-side return current Ib1 flows through the fourth flywheel diode Dd, the voltage across the terminals of the fourth switching element Sd is reduced to the level of the forward voltage of the fourth flywheel diode Dd. Then, as shown in FIG. 11, the fourth switching element Sd is turned on [i.e., state (H) in FIG. 2].

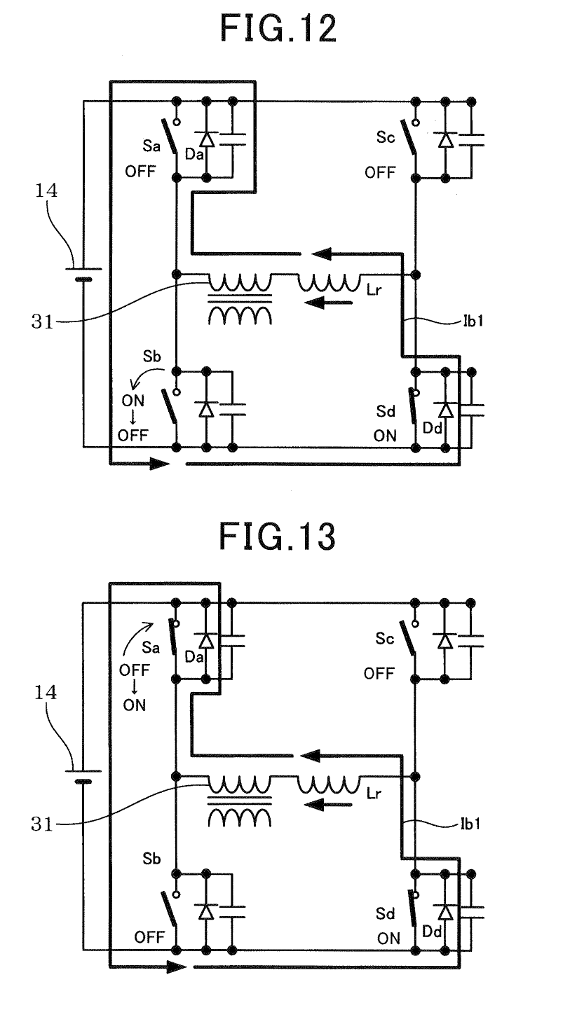

Then, while the primary-side return current Ib1 keeps flowing, the second switching element Sb is turned off [i.e., state (I) in FIG. 2], as shown in FIG. 12. In this state, the primary-side return current ib1 flows through a closed circuit composed of a first flywheel diode Da, the power source 14, the fourth flywheel diode Dd, the resonant inductance Lᵣ and the primary coil 31.

When the primary-side return current Ib1 flows through the first flywheel diode a, the voltage across the terminals of the first switching element Sa is reduced to the level of the forward voltage of the first flywheel diode Da. Then, as shown in FIG. 13, the first switching element Sa is turned on [i.e., state (J) in FIG. 2].

After a while in this state, the primary-side return current Ib1 is attenuated and, as shown in FIG. 4, the primary current i1 starts flowing. The primary current I1 flows through the first switching element Sa, the primary coil 31, the resonant inductance Lᵣ and the fourth switching element Sd.

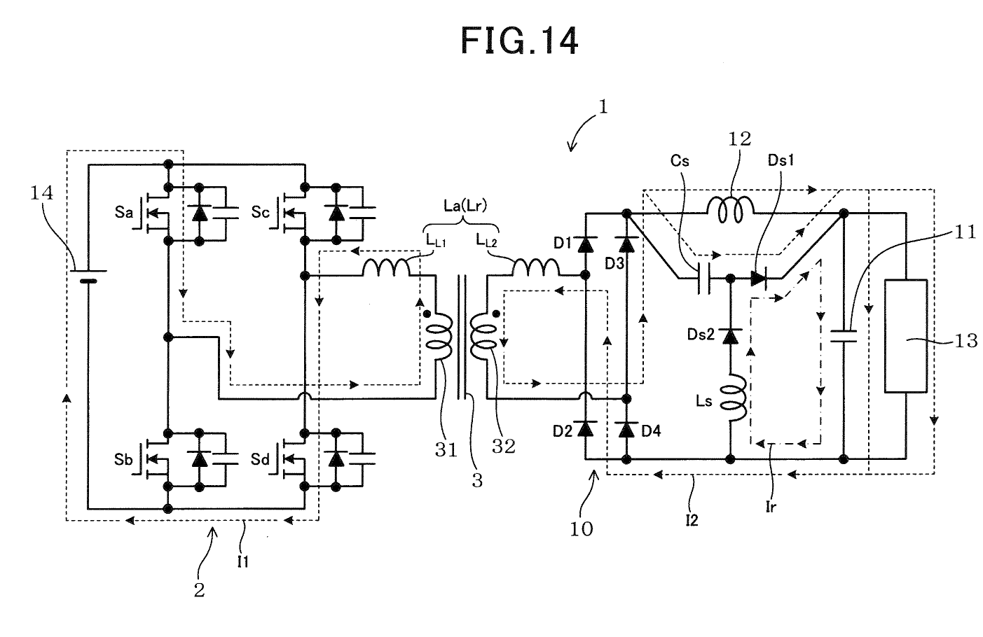

As described above, when the full-bridge circuit is operated under phase-shift control, the primary current I1 and the primary-side return current Ib1 alternately flow through the primary coil 31. This alternate current flow accompanies alternate current flow of the secondary current I2 and a secondary-side return current Ib2 in the secondary coil 32 of the transformer 3. Specifically, every time the direction of the voltage applied to the transformer 3 is changed, the current flowing through the transformer 3 changes its direction of flow. For example, as shown in FIG. 14, when only the first and fourth switching elements Sa and Sd of the full-bridge circuit 2 are turned on, the primary current I1 directed to a direction opposite to the direction up to then flows through the primary coil 31. Similarly, the secondary current I2 directed to a direction opposite to the direction up to then flows through the secondary coil 32. When a reverse voltage is applied to the diodes that have been electrically conductive, the state of the diodes changes from the electrically conductive state to an electrically non-conductive state. In this instance, a reverse recovery current flows through the diodes concerned. The recovery current, coupled with the total leakage inductance Lₐ, generates a surge voltage.

As shown in FIG. 14, the secondary current I2, after flowing through the third rectifier diode D3, flows via (i) a path along the smoothing inductance 12 and the smoothing capacitor 11, (ii) a path along the smoothing inductance 12 and the load 13, and (iii) a path along the snubber capacitor Cs, the first diode Ds1 and the smoothing capacitor 11, through the second rectifier diode D2. During this flow of the secondary current I2, the snubber capacitor Cs accumulates electric charges. The snubber capacitor Cs absorbs the surge voltage which is generated every time the direction of the voltage applied to the transformer 3 is alternately changed. Thus, the rectifier diodes D1 to D4 are prevented from being applied with a large surge voltage.

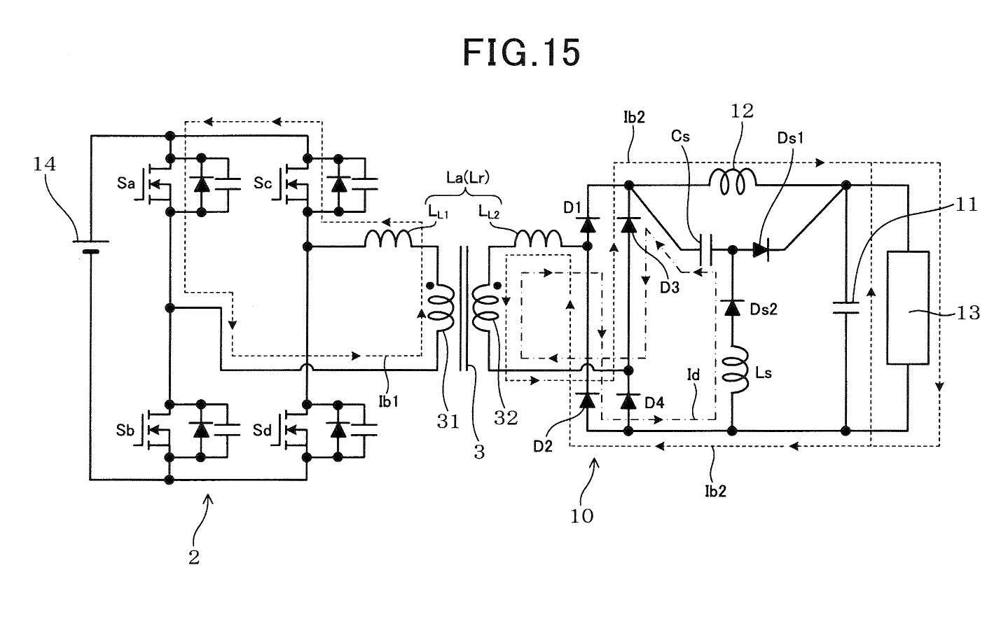

FIG. 15 shows a state where the fourth switching element Sd is turned off, with the first switching element Sa being in an on state. In this state, the primary-side return current Ib1 starts flowing through the primary coil 31. At the same time, the secondary-side return current Ib2 starts flowing through the secondary coil 32. The secondary-side return current Ib2 flows through the secondary coil 32, the third rectifier diode D3, the smoothing inductance 12, the load 13, the second rectifier diode D2 and the secondary-side leakage inductance L_{L2}.

With the flow of the secondary-side return current Ib2, the secondary voltage of the secondary coil 32 is lowered and thus the voltage applied to the snubber capacitor Cs is also lowered. Therefore, the snubber capacitor Cs discharges the accumulated electric charges. The discharging current Id of the snubber capacitor Cs flows in a direction opposite to that of the secondary-side return current Ib2 so as to reduce the secondary-side return current Ib2. The discharging current Id flows through a closed circuit composed of the snubber capacitor Cs, the third rectifier diode D3, the secondary coil 32, the secondary-side leakage inductance L_{L2}, the second rectifier diode D2, the snubber inductance Ls and the second diode Ds2.

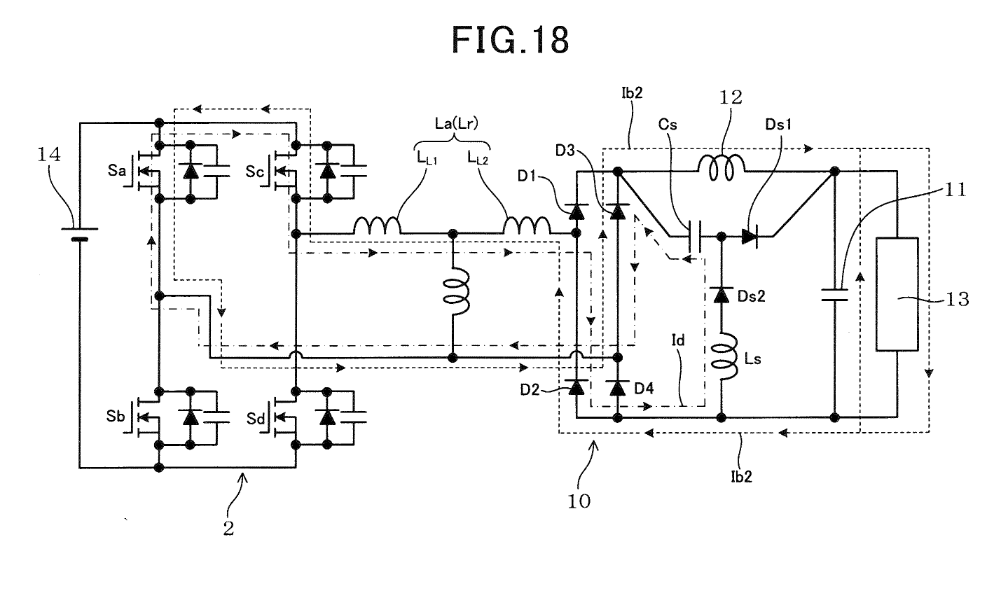

In the circuit shown in FIG. 15, the discharging current Id flows through only the secondary-side leakage inductance L_{L2}. However, as shown in FIG. 18, from the perspective of an equivalent circuit, the discharging current Id may be regarded as flowing through the total leakage inductance Lₐ.

Thus, the path through which the discharging current Id flows includes the total leakage inductance Lₐ (resonant inductance Lᵣ) as seen from the secondary side and the snubber inductance Ls. Accordingly, flow of a high discharging current Id is prevented by these inductances Lr and Ls. During the flow of the discharging current Id, the inductance Ls accumulates energy.

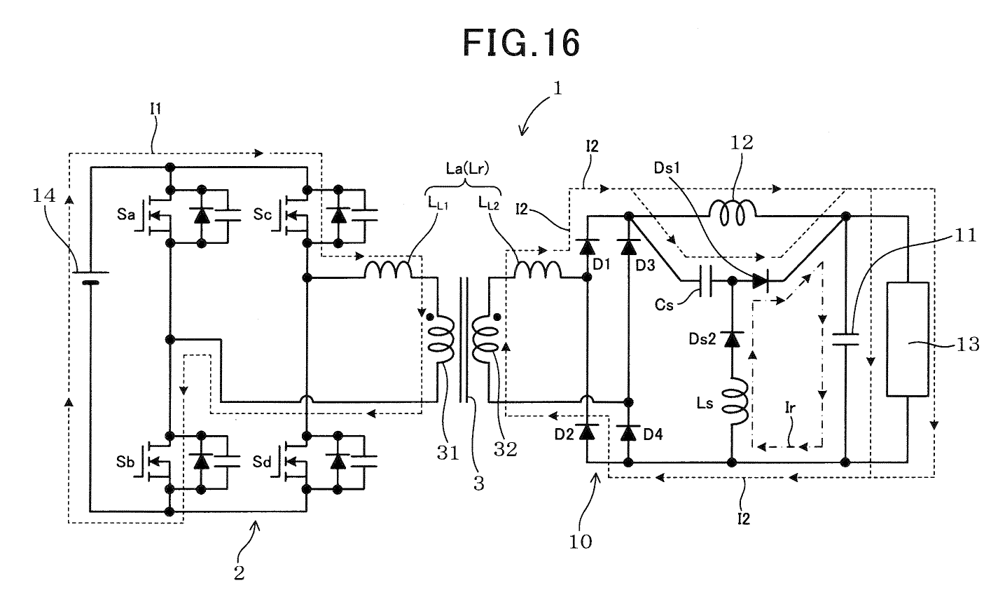

FIG. 16 shows a state where only the second and third switching elements Sb and Sc of the full-bridge circuit 2 are turned on. In this state, the primary current I1 flows through the primary coil 31 and the secondary current I2 flows through the secondary coil 32. The directions of the flow of the primary and secondary currents I1 and 12 in FIG. 16 are each opposite to those shown in FIG. 14.

The secondary current I2, after flowing through the first rectifier diode D1, flows via (i) a path along the smoothing inductance 12 and the smoothing capacitor 11, (ii) a path along the smoothing inductance 12 and the load 13, and (iii) a path along the snubber capacitor Cs, the first diode Ds1 and the smoothing capacitor 11, through the fourth rectifier diode D4. During this flow of the secondary current I2, the snubber capacitor Cs accumulates electric charges. The snubber capacitor Cs absorbs the surge voltage which is generated every time the direction of the voltage applied to the transformer 3 is alternately changed. Thus, the rectifier diodes D1 to D4 are prevented from being applied with a large surge voltage.

Further, during the flow of the secondary current I2, the snubber inductance Ls discharges the energy that has been absorbed when the snubber capacitor Cs has discharged the electric charges (see FIG. 15). This energy as a regeneration current Ir flows through a closed circuit composed of the snubber inductance Ls, second diode Ds2, first diode Ds1 and smoothing capacitor 11.

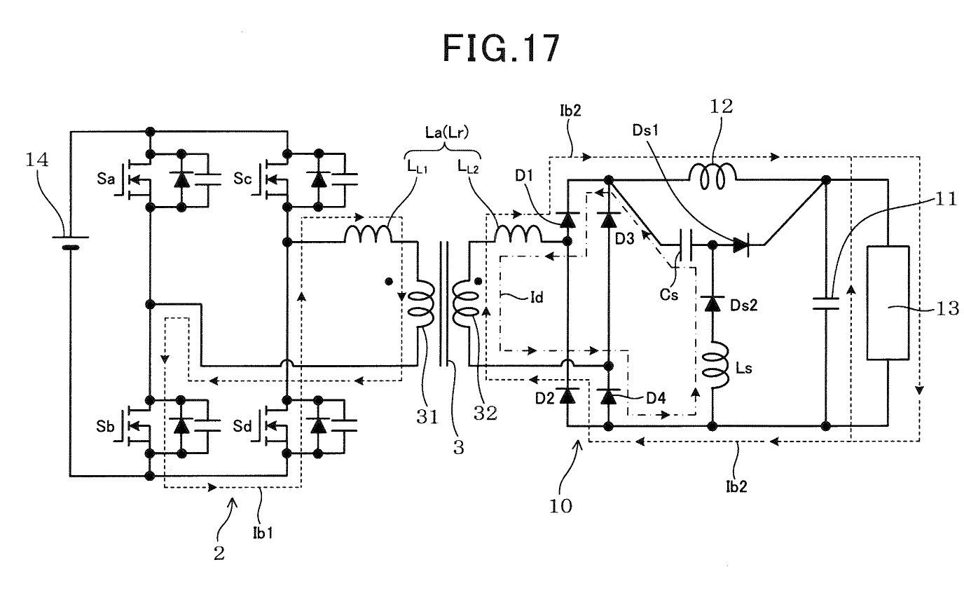

FIG. 17 shows a state where the third switching element Sc of the full-bridge circuit 2 is turned off with the second switching element Sb being in an on state. In this state, the primary-side return current Ib1 flows through the primary coil 31, and the secondary-side return current Ib2 flows through the secondary coil 32. The secondary-side return current Ib2 flows through the secondary coil 32, secondary-side leakage inductance L_{L2}, first rectifier diode D1, smoothing inductance 12, load 13 and fourth rectifier diode D4.

With the flow of the secondary-side return current Ib2, the secondary voltage of the secondary coil 32 is lowered and thus the voltage applied to the snubber capacitor Cs is also lowered. Therefore, the snubber capacitor Cs discharges the accumulated electric charges (discharging current Id). The discharging current Id of the snubber capacitor Cs flows in a direction opposite to that of the secondary-side return current Ib2 so as to reduce the secondary-side return current Ib2. The discharging current Id flows through a closed circuit composed of the snubber capacitor Cs, first rectifier diode D1, secondary-side leakage inductance L_{L2}, secondary coil 32, fourth rectifier diode D4, snubber inductance Ls and second diode Ds2.

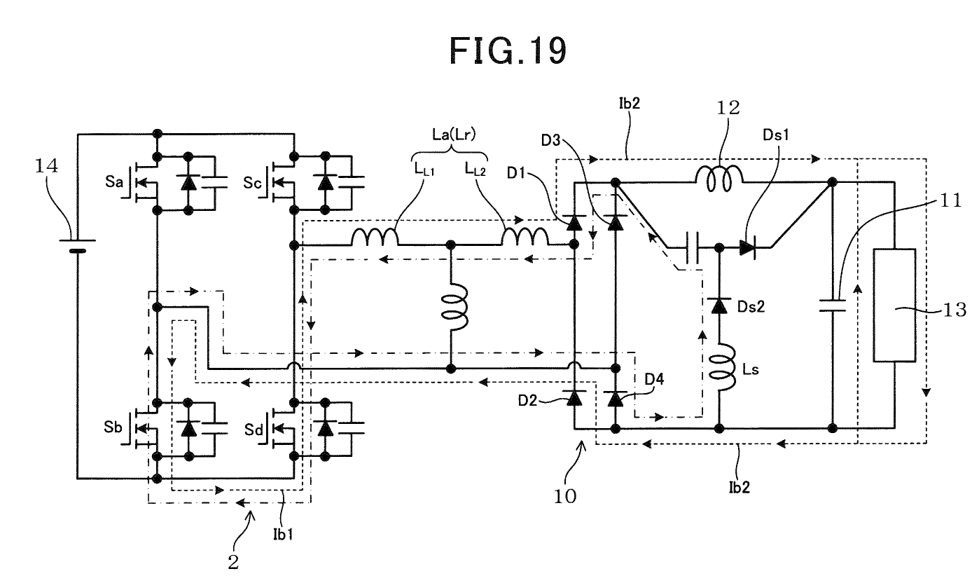

In the circuit shown in FIG. 17, the discharging current Id flows through only the secondary-side leakage inductance L_{L2}. However, as shown in FIG. 19, from the perspective of an equivalent circuit, the discharging current Id may be regarded as flowing through the total leakage inductance Lₐ.

The snubber inductance Ls accumulates energy with the flow of the discharging current Id. This energy is discharged as the regeneration current Ir, as shown in FIG. 14, when the secondary current I2 again flows through the switching power supply device 1. The regeneration current Ir flows through a closed circuit composed of the snubber inductance Ls, second diode Ds2, first diode Ds1 and smoothing capacitor 11.

The advantages of the present embodiment are described below. In the present embodiment, the switching elements Sa to Sd of the full-bridge circuit 2 are operated under phase-shift control. Phase-shift control exerts an effect of flowing the secondary-side return current Ib2 through the secondary coil 32 of the transformer 3 during the period when the snubber capacitor Cs carries out discharging (see FIGS. 15 and 17). The discharging current Id of the snubber capacitor Cs flows in a direction of reducing the secondary-side return current Ib2.

As described above, it will be understood from the equivalent circuits of FIGS. 15 and 17 (FIGS. 18 and 19) that the discharging current Id flows through the total leakage inductance Lₐ. Thus, an excessive discharge of electric charges is suppressed by the total leakage inductance Lₐ to thereby reduce the discharging current Id. When the excessive discharging current is suppressed, excessive charging current of the snubber capacitor Cs is also suppressed. As a result, power loss of the switching power supply device 1 is reduced. In addition, even when the capacitance of the snubber capacitor Cs is increased, the discharging current does not become excessive. Therefore, a snubber capacitor Cs having a large capacitance may be used to more easily absorb the surge voltage. Thus, the rectifier diodes D1 to D4 are more easily protected.

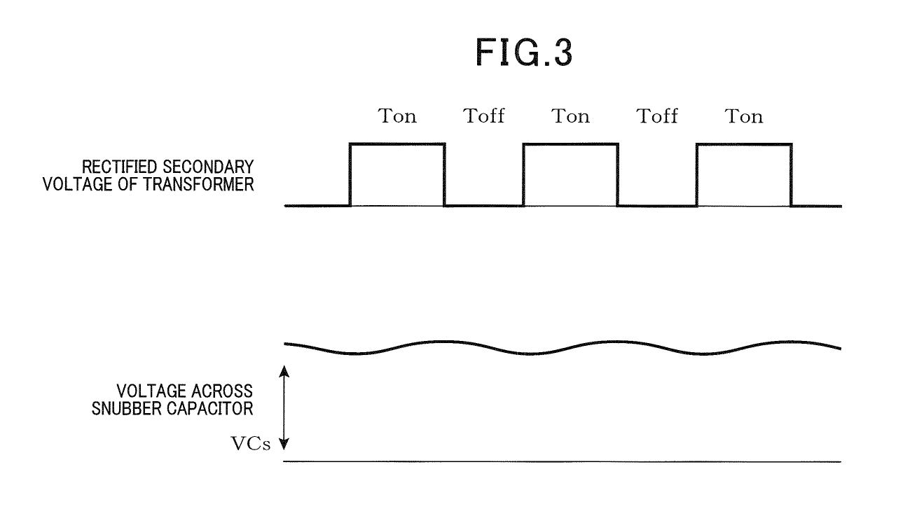

As shown in FIG. 3, the present embodiment is configured to control the switching elements Sa to Sd in such a way that an on state Tₒₙ where the secondary coil 32 outputs a secondary voltage repeatedly alternates with an off state T_{off} where the secondary coil 32 does not output the secondary voltage. Further, in the present embodiment, the capacitance of the snubber capacitor Cs is determined so that the voltage across the snubber capacitor Cs is not reduced to 0 V in the off state T_{off}.

In other words, the snubber capacitor Cs used in the present embodiment has so large a capacitance that does not permit the voltage across the snubber capacitor Cs to be reduced to 0 V in the off state T_{off}. Thus, the surge voltage of the secondary coil 32 can be effectively absorbed.

Further, as shown in FIG. 1, the switching power supply device 1 of the present embodiment includes the second series connection 5 composed of the second diode Ds2 and the impedance 50 for discharging electric charges, which are connected in series. The second series connection 5 is provided between the connecting point 64, through which the snubber capacitor Cs is connected to the first diode Ds1, and the negative-side output terminal 63 of the rectifier circuit 10.

Thus, since the discharging current Id of the snubber capacitor Cs flows through both of the total leakage inductance Lₐ and the impedance 50, the discharging current Id is more effectively reduced. Accordingly, the capacitance of the snubber capacitor Cs can be easily increased as desired and thus the surge voltage is easily absorbed. At the same time, power loss of the switching power supply device 1 is more effectively reduced.

Furthermore, the present embodiment uses an inductance (snubber inductance Ls) as the impedance 50 for discharging electric charges.

With this configuration, the amount of generated heat is reduced when the discharging current Id flows through the switching power supply device 1, compared to the case where a resistor is used as the impedance 50. Thus, power loss of the switching power supply device 1 is easily reduced.

As described above, the switching power supply device 1 according to the present embodiment is able to easily reduce the surge voltage and suppress power loss.

### Second Embodiment

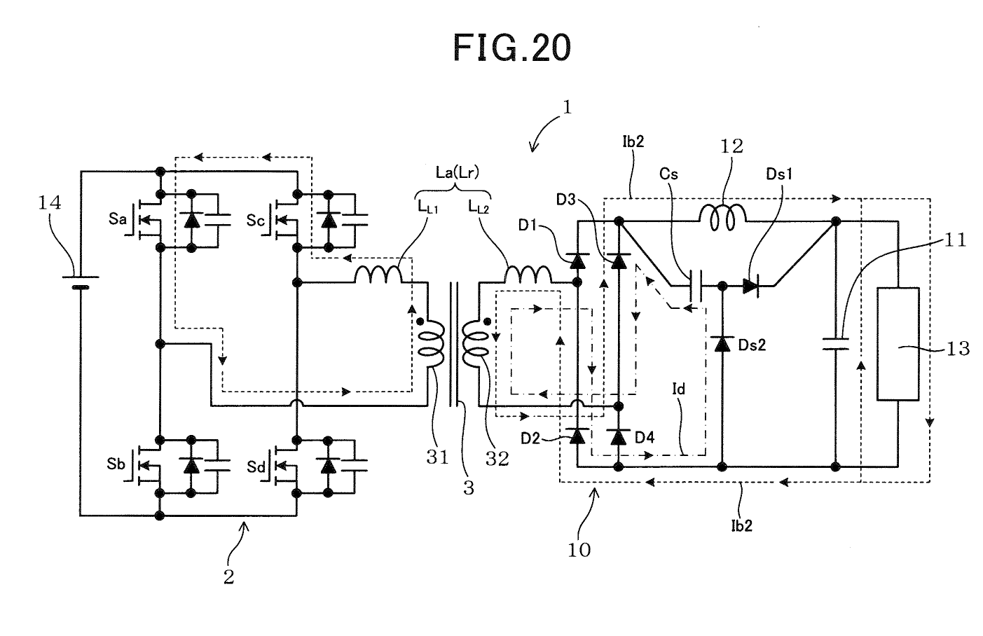

Referring now to FIG. 20, a second embodiment of the present invention is described. In the second and the subsequent embodiments as well as in the experiments set forth below, the components identical with or similar to those in the first embodiment are given the same reference numerals for the sake of omitting unnecessary explanation.

FIG. 20 is a circuit diagram illustrating a switching power supply device 1 according to the second embodiment. As shown in FIG. 20, the switching power supply device 1 of the present embodiment is not provided with the snubber inductance Ls (the impedance 50 for discharging electric charges) but, instead, the anode of the second diode Ds2 is connected to the negative-side power line 6n.

With this configuration, the path through which the discharging current Id of the snubber capacitor Cs flows includes only the total leakage inductance Lₐ. Accordingly, the effect of suppressing the discharging current Id is small compared to the switching power supply device 1 of the first embodiment. However, in the absence of the snubber inductance Ls, the number of components is reduced and thus the manufacturing cost of the switching power supply device 1 is reduced.

The remaining configuration and the advantages obtained therefrom are the same as those of the first embodiment.

The present embodiment uses the total leakage inductance Lₐ as a resonant inductance Lᵣ for phase-shift control. However, an additional resonant inductance Lα, not shown, may be connected in series with the total leakage inductance Lₐ in order to reduce switching loss in phase-shift control. In this case, the sum of the additional resonant inductance Lα and the total leakage inductance Lₐ corresponds to the resonant inductance Lᵣ.

### Third Embodiment

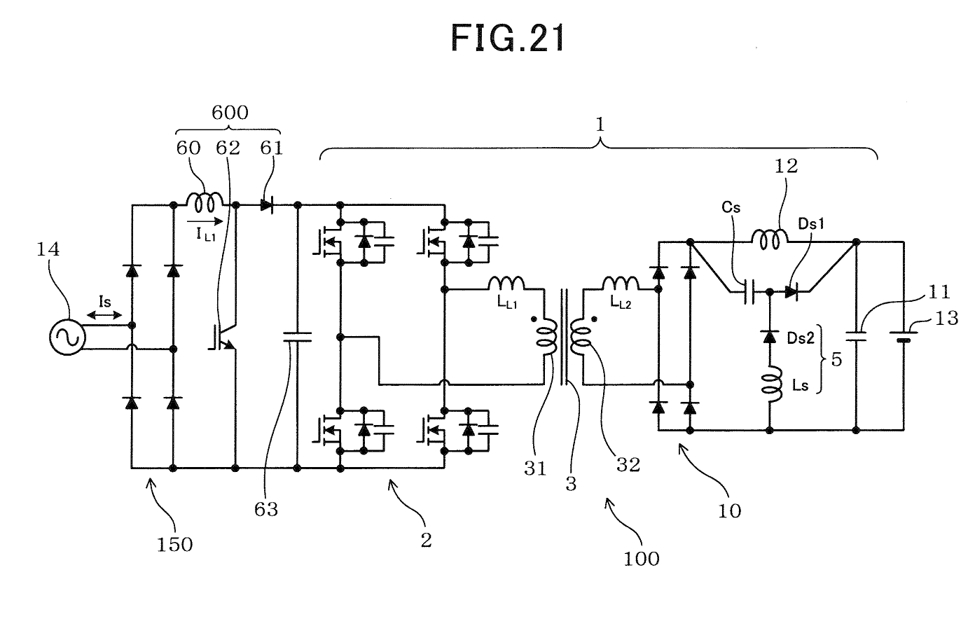

Referring to FIG. 21, a third embodiment of the present invention is described. FIG. 21 is a circuit diagram illustrating a switching power supply device 1 according to the third embodiment. As shown in FIG. 21, the switching power supply device 1 is used as a battery charger 100 in the present embodiment. The battery charger 100 is used for charging a battery (load 13) installed in an electric car, a hybrid car or the like, from a domestic commercial power source (power source 14).

The battery charger 100 includes a rectifier circuit 150 connected to the power source 14, a PFC (power factor correction) circuit 600 and the switching power supply device 1. The PFC circuit 600 includes a choke coil 60, an IGBT (insulated gate bipolar transistor) element 62, a diode 61 for preventing discharging, and a smoothing capacitor 63 for PFC. The battery charger 100 carries out on/off control of the IGBT element 62 to correct a reactor current I_{L1} flowing through the choke coil 60 to a waveform approximate to a sine wave. Thus, the waveform of an input current Is is less distorted to thereby enhance the power factor of the electric power supplied from the power source 14.

In this way, the battery charger 100 is configured to enhance the power factor of the electric power using the PFC circuit 600 and then to apply a DC voltage to the full-bridge circuit 2 of the switching power supply device 1.

### Example

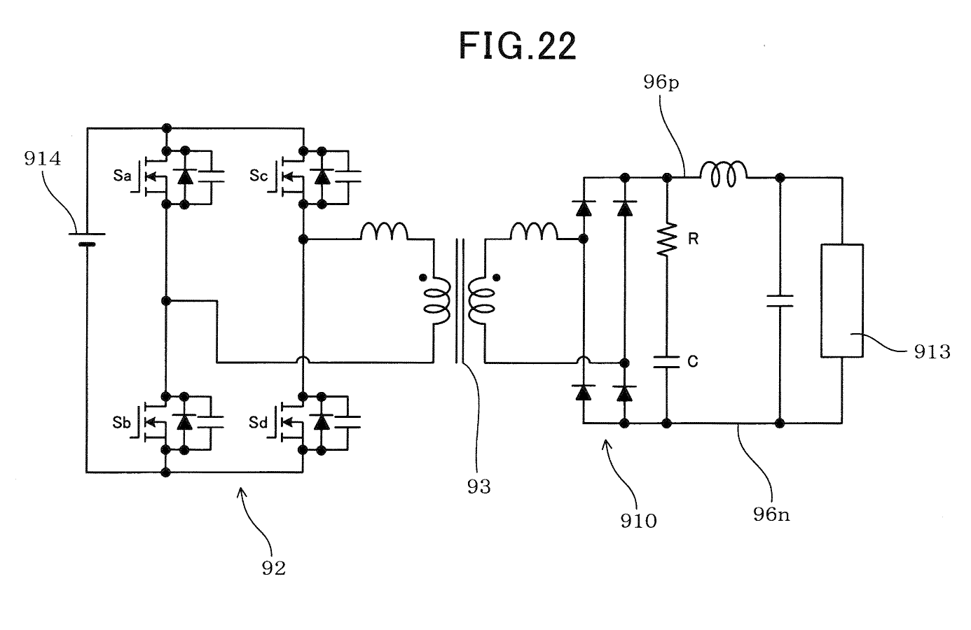

Experiments were conducted to confirm the effects of the switching power supply device of the present embodiment. First, an experiment was conducted using a circuit out of the scope of the present embodiment, as shown in FIG. 22, which included neither the first series connection 4 nor the second diode Ds2. The circuit shown in FIG. 22, which is connected between a load 913 and a power source 914, includes a rectifier circuit 910, a full-bridge circuit 92 and a transformer 93. In the circuit, a positive-side power line 96p was connected to a negative-side power line 96n via a resistor R and a capacitor C which were connected in series. The switching elements Sa to Sd of the circuit were turned on/off to confirm the waveforms of the secondary voltage and the secondary current of the transformer 93.

In the experiment, the capacitance of the capacitor C was set to 3000 pF and the resistance of the resistor R was set to 22Ω. Further, a ratio of the number of turns of the primary coil to the secondary coil of the transformer 93 was set to two to three. Also, MOSFETs were used as the switching elements S. The diodes and the capacitors connected in parallel with the respective switching elements S were rendered to be parasitic diodes and parasitic capacitors of the respective MOSFETs.

The full-bridge circuit 92 was turned on/off under so-called hard-switching control and phase-shift control to confirm the waveforms of the secondary voltage and the secondary current of the transformer 93 under these controls.

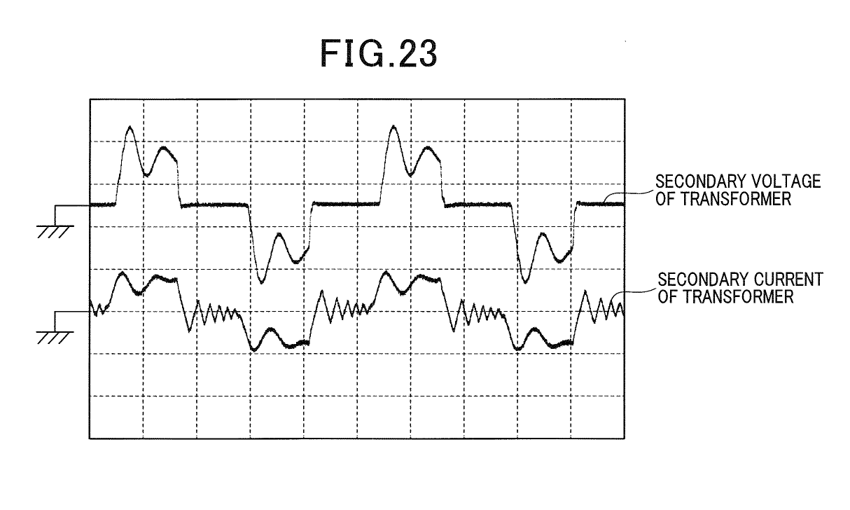

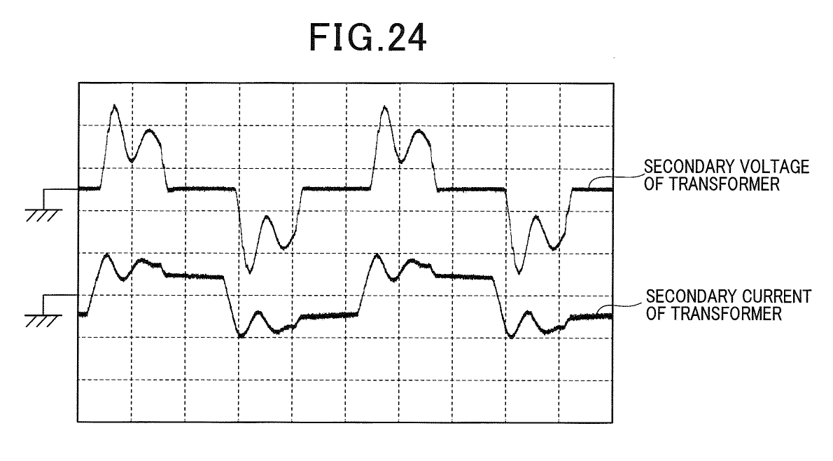

Under hard-switching control, the first and fourth switching elements Sa and Sd were ensured to be synchronized, and the second and third switching elements Sb and Sc were ensured to be synchronized. Further, duration of the on state of the switching elements Sa to Sd was controlled to thereby adjust the voltage applied to the load 913. In the experiment, duties of the switching elements Sa to Sd and a value of the load 913 were controlled so that the voltage of the DC input power source 914 would be 400 V, the voltage of the load 913 would be 260 V and the power of the load 913 would be 3300 W. FIG. 23 is a graph showing waveforms of the secondary voltage and the secondary current under hard-switching control. FIG. 24 is a graph showing waveforms under phase-shift control.

As will be seen from FIGS. 23 and 24, the circuit shown in FIG. 22 generated surge voltage under both of hard-switching control and phase-shift control. This is because, unlike in the circuit shown in FIG. 1, the capacitance of the capacitor C in the circuit of FIG. 22 is difficult to be sufficiently increased and thus the capacitor C cannot sufficiently absorb the surge voltage.

Also, under hard-switching control, the circuit shown in FIG. 22 exerted a power efficiency (percentage that input power is transferred to the load) of 83.8%. Under phase-shift control, the power efficiency was 87.4%. Comparing hard-switching control with phase-shift control, the efficiency of phase-shift control was improved by 3.6% percentage points. This is because, under phase-shift control, switching loss of the switching elements is lowered. Further, under phase-shift control, transformer's current is not oscillated, because circulating current flows through the transformer's winding while no primary voltage is applied to the transformer. Accordingly, the increase of high-frequency loss is suppressed such as in the transformer's winding, which would have been increased under hard-switching control due to the oscillation of the transformer's current. In this way, the efficiency in phase-shift control is higher than in hard-switching control.

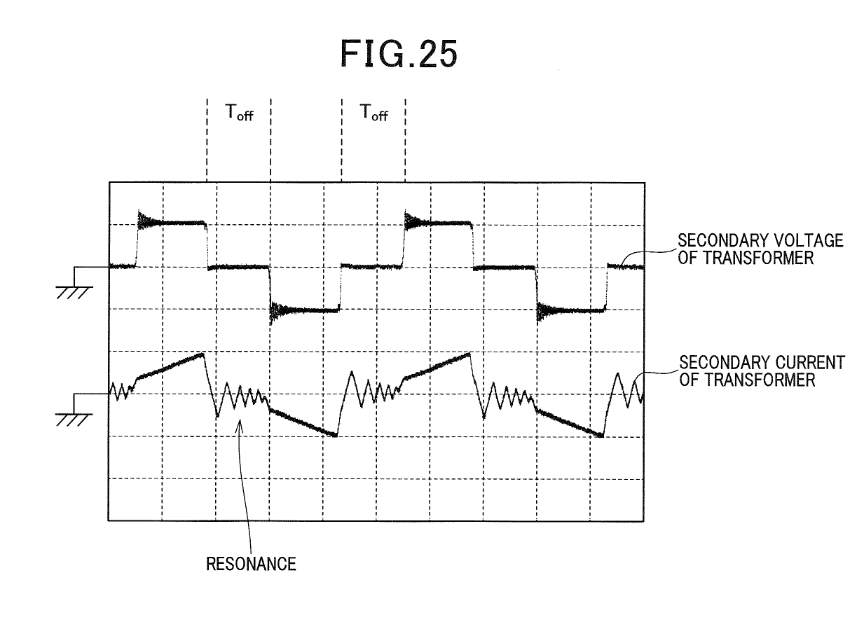

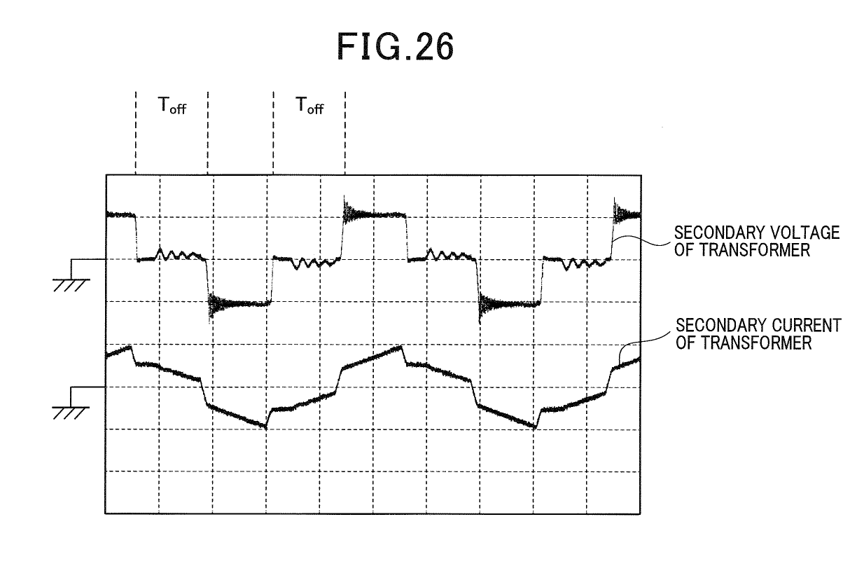

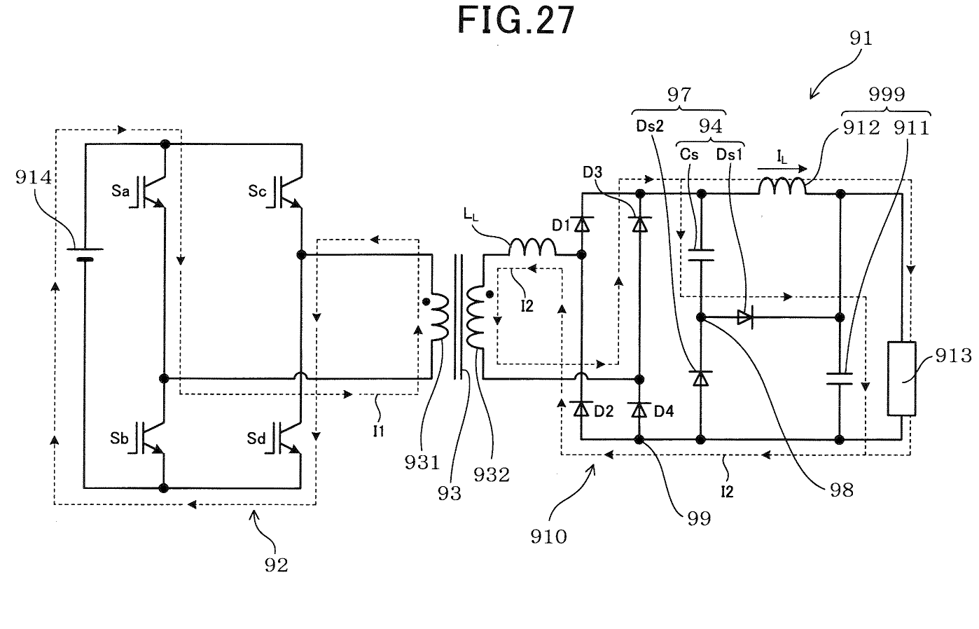

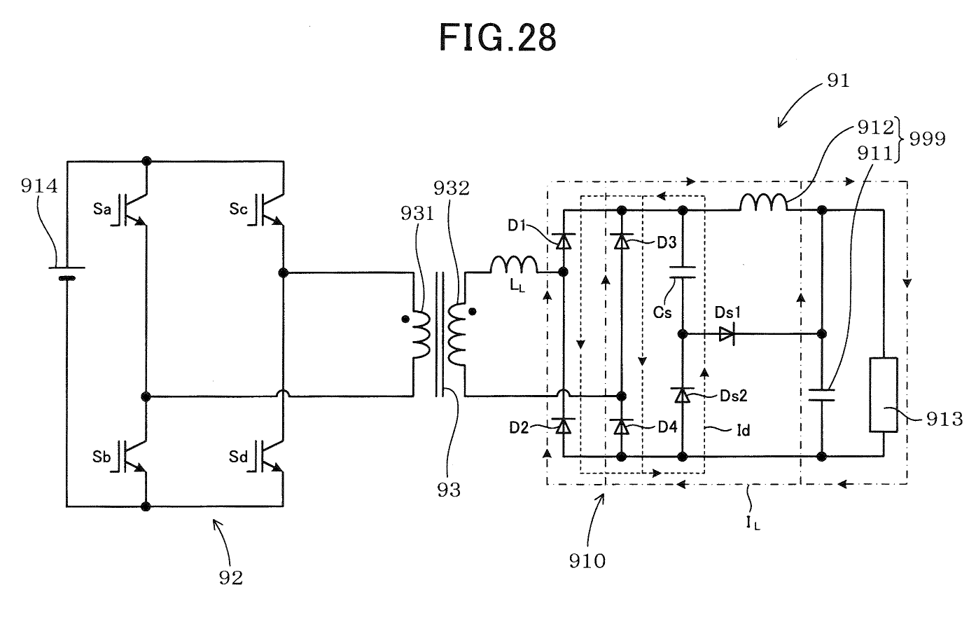

Further, another experiment was conducted using the circuit shown in FIG. 1. In the experiment, the switching elements Sa to Sd of the full-bridge circuit 2 were turned on/off. In this case, the capacitance of the snubber capacitor Cs was set to 1 μF and the snubber inductance Ls was set to 100 μH. A ratio of the number of turns of the primary coil 31 to the secondary coil 32 of the transformer 3 was set to two to three respectively. The full-bridge circuit 2 was operated under two types of control, i.e. hard-switching control and phase-shift control, to confirm the waveforms of the secondary voltage and the secondary current of the transformer 3. The voltages of the DC input power source 14 and the load 13 were set to the same level as in the experiment using the circuit shown in FIG. 22. FIG. 25 is a graph showing waveforms of the secondary voltage and the secondary current under hard-switching control. FIG. 26 is a graph showing waveforms under phase-shift control.

As will be seen from FIG. 25, under hard-switching control, the circuit shown in FIG. 1 reduced surge voltage but produced resonance in the secondary current during the off state T_{off} where secondary voltage was not generated. Production of resonance in the secondary current causes reduction of power efficiency.

Further, the circuit shown in FIG. 1 exerted the power efficiency of 86.8% under hard-switching control, showing an improvement of 3.0 percentage points compared to the circuit conditions shown in FIG. 22.

Further, as will be seen from FIG. 26, under phase-shift control, the circuit shown in FIG. 1 reduced surge voltage and hardly exhibited oscillating current in the waveform of the transformer's current. In this case, the power efficiency was 91.5%, showing an improvement of 4.1% percentage points compared to the circuit conditions shown in FIG. 22.

As will be seen, the improvement in the power efficiency is higher in the combination of phase-shift control and a snubber circuit than in the combination of hard-switching control and a snubber circuit. This is because high-frequency loss that would be caused by oscillating current is reduced in the transformer's winding under phase-shift control. In addition, under phase-shift control, reverse current in a period when no transformer's primary voltage is applied is sufficiently lowered to thereby suppress the excessive charging/discharging current of the snubber capacitor Cs. Thus, loss in the switching elements and the transformer's winding is reduced. In this way, the combination of phase-shift control and a snubber circuit shows a higher improvement in the power efficiency.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

1. A switching power supply device, comprising:
a full-bridge circuit that includes a plurality of switching elements which are controlled to be driven under phase-shift control;
a transformer that includes a primary coil and a secondary coil, the primary coil being connected to an output terminal of the full-bridge circuit;
a rectifier circuit that is connected to the secondary coil of the transformer and rectifies a secondary voltage outputted from the secondary coil;
a filter circuit that includes a smoothing capacitor and a smoothing reactor, which smooths the rectified secondary voltage;
a first series connection that is configured by a snubber capacitor and a first diode which are connected in series with each other, the first series connection being connected in parallel with the smoothing reactor, one terminal of the snubber capacitor being connected to a terminal on a positive side of the rectifier circuit, the other terminal of the snubber capacitor being connected to an anode of the first diode, and a cathode of the first diode being connected to one terminal of the smoothing capacitor which is applied with positive voltage; and
a second diode that is provided between a terminal on a negative side of the rectifier circuit and a connecting point of the snubber capacitor and the first diode, a cathode of the second diode being connected to a side of the connecting point.

2. The switching power supply device according to claim 1, further comprising:
a second series connection of the second diode and an impedance that are connected in series with each other, the second series connection being provided between the connecting point and the terminal on the negative side of the rectifier circuit.

3. The switching power supply device according to claim 2, wherein the impedance is an inductance.

4. The switching power supply device according to claim 1, wherein
the switching elements are controlled to be driven in such a manner that an on state where the secondary coil outputs a secondary voltage repeatedly alternates with an off state where the secondary coil does not output the secondary voltage, and
the snubber capacitor has capacitance which is set so that voltage across the snubber capacitor is not reduced to zero volts in the off state.

5. The switching power supply device according to claim 1, wherein
the switching elements includes first to fourth switching elements, where the first and third switching elements are a first pair of an upper-arm and lower-arm switching elements, and the second and fourth switching elements are a second pair of an upper-arm and lower-arm switching elements,
in a first state where the first and fourth switching elements are turned on and the second and third switching elements are turned off, a primary current flows through the primary coil and a secondary current flows through the secondary coil,
in a second state where, under the first state, the fourth switching element is turned off and subsequently the third switching element is turned on, a primary-side return current flows through the primary coil and a secondary-side return current flows through the secondary coil via a series circuit of a primary-side leakage inductance and a secondary-side leakage inductance of the transformer,
in a third state where the second and third switching elements are turned on and the first and fourth switching elements are turned off, the primary current flows through the primary coil in a direction opposite to that of the first state and the secondary current flows through the secondary coil in a direction opposite to that of the first state,
in a fourth state where, under the third state, the third switching element is turned off and subsequently the fourth switching element is turned on, the primary-side return current flows through the primary coil in a direction opposite to that of the second state and the secondary-side return current flows through the secondary coil via the series circuit of the primary-side leakage inductance and a secondary-side leakage inductance in a direction opposite to that of the second state, and
when the secondary-side return current flows, the snubber capacitor carries out discharging to allow a discharging current to flow in a direction opposite to that of the secondary-side return current so as to reduce the secondary-side return current.

6. The switching power supply device according to claim 5, wherein
a total leakage inductance of the primary-side leakage inductance and the secondary-side leakage inductance is used as a resonant inductance for phase-shift control that allows the secondary-side return current to flow through the secondary coil of the transformer when the snubber capacitor carries out discharging.

7. The switching power supply device according to claim 6, wherein
the total leakage inductance and an additional resonant inductance connected in series with the total leakage inductance are used as the resonant inductance for phase-shift control.

8. A battery charger, comprising:
a first rectifier circuit that is connected to an output terminal of a power source;
a power factor correction circuit that is connected to an output terminal of the first rectifier circuit; and
a switching power supply device that is connected to the PFC circuit and includes:
a full-bridge circuit that includes a plurality of switching elements which are controlled to be driven under phase-shift control;
a transformer that includes a primary coil and a secondary coil, the primary coil being connected to an output terminal of the full-bridge circuit;
a second rectifier circuit that is connected to the secondary coil of the transformer and rectifies a secondary voltage outputted from the secondary coil;
a filter circuit that includes a smoothing capacitor and a smoothing reactor, which smooths the rectified secondary voltage;
a first series connection that is configured by a snubber capacitor and a first diode which are connected in series with each other, the first series connection being connected in parallel with the smoothing reactor, one terminal of the snubber capacitor being connected to a terminal on a positive side of the second rectifier circuit, the other terminal of the snubber capacitor being connected to an anode of the first diode, and a cathode of the first diode being connected to one terminal of the smoothing capacitor which is applied with positive voltage; and
a second diode that is provided between a terminal on a negative side of the second rectifier circuit and a connecting point of the snubber capacitor and the first diode, a cathode of the second diode being connected to a side of the connecting point.

9. The battery charger according to claim 8, wherein
the switching power supply device further includes:
a second series connection of the second diode and an impedance that are connected in series with each other, the second series connection being provided between the connecting point and the terminal on the negative side of the rectifier circuit.

10. The battery charger according to claim 8, wherein
the switching elements are controlled to be driven in such a manner that an on state where the secondary coil outputs a secondary voltage repeatedly alternates with an off state where the secondary coil does not output the secondary voltage, and
the snubber capacitor has capacitance which is set so that voltage across the snubber capacitor is not reduced to zero volts in the off state.
